(19) United States
(12) Patent Application Publication
(10) Pub. No.: US 2013/0082131 A1
(43) Pub. Date: Apr. 4, 2013

(54) BLADE BIT FOR CRUSHER ROTOR

(71) Applicant: Ilkka Haalisto, Rauma (FI)

(72) Inventor: Ilkka Haalisto, Rauma (FI)

(73) Assignee: BMH Technology Oy, Rauma (FI)

(21) Appl. No.: 13/701,590

(22) PCT Filed: Jul. 6, 2011
(86) PCT No.: PCT/FI2011/050635

§ 371 Date: Dec. 3, 2012

(30) Foreign Application Priority Data
Jul. 7, 2010 (FI) 20105777

(51) Int. Cl. B02C 18/18

(52) U.S. Cl. CPC B02C 18/18
USPC 241/294

(57) ABSTRACT

The invention relates to a blade bit to be attached to a chuck in an envelope surface of a crusher rotor, the blade bit (1) having four corners and arranged for being attached to the chuck such that an angular-shaped tip of the blade bit points outwardly from the envelope surface, substantially in the radial direction of the rotor, whereby the rear surface of the blade bit, which acts as its attachment surface to the chuck, comprises a support surface (9) preventing the blade bit from rotating, which support surface also enables sliding of the blade bit towards the envelope surface (3), when the blade bit is being attached, until the blade bit is supported to the envelope surface.

### BACKGROUND OF THE INVENTION

The invention relates to a blade bit to be attached to a chuck in an envelope surface of a crusher rotor, the blade bit having four corners and arranged for being attached to the chuck such that an angular-shaped tip of the blade bit pointing outwardly from the envelope surface, substantially in the radial direction of the rotor, whereby the rear surface of the blade bit, which acts as its attachment surface to the chuck, comprises a support surface, that prevents the blade bit from rotating and that also enables sliding of the blade bit towards the envelope surface, when the blade bit is being attached, until the blade bit is supported to the envelope surface.

The crushers typically employ dynamic and static blades. All blades may also be dynamic.

The blades may be made of various materials, such as steels. Blade properties may be improved in various ways, such as thermal treatments and coatings. The thermal treatment allows sufficient endurance and functionality to be achieved against wear and impacts. The blades must also stay sharp in operations where cutting is required.

The blades may also be coated by using various methods that include, for instance, detonation, PTA (Plasma Transferred Arc) spraying, HVOF (High Velocity Oxygen Fuel Thermal Spray Process), laser hybrid welding/melting processes, when coatings used are typically powders, in which carbides and metal powders are combined. For welding it is also possible to use MIG, MAG and TIG welding, metal arc welding and various soldering methods.

The blades may be attached to chuck structures of a crusher rotor with bolted joints or other attachment arrangements.

When crushing materials that are elastic or soft, it is common to use blade technology that is based on cutting the material. For a successful operation it is essential that cutting allowance is as small as possible. In practice, this requirement also necessitates allowance adjustment so as to compensate for wearing.

It is known technology to use as cutting blades replaceable blade bits having the basic shape of a square and the front surface that is either flat or concave. They are attached to chucks on the envelope surface of the crusher rotor by using a screw passing through the chuck such that it utilizes the blade bit as a nut. A corner of the blade bit square points thus outwardly from the envelope surface in the radial direction of the rotor. Lateral positioning is typically provided by means of a V-groove on the rotor surface and a large hole in the chuck.

As the tip of the blade bit and the cutting edges downwardly therefrom wear (become dull), the cutting capacity degrades and a need for force increases. In that case the blade bit is rotated 90 degrees or 180 degrees and consequently sharp edges and a tip will be in use.

After rotation, the blade surfaces used for support are typically worn and consequently the guiding effect in the V-groove of the envelope surface of the crusher rotor is not necessarily appropriate. The blade may also assume a slightly slanted position, if one blade bit side is more worn than the other. This, in turn, has a consequence that blade allowance adjustment, which often takes place by adjusting blocks consisting of several blade bits, cannot achieve the desired allowance. The slanted blade bit defines the allowance of the whole adjustment block, and typically, the allowance is clearly larger than desired.

### SUMMARY OF THE INVENTION

The object of the present invention is thus to provide an improved blade bit for a crusher rotor of the above type, by which the above-mentioned problems may be solved. This objective is achieved by a blade bit of the invention, which is characterized in that a support surface comprises at least one groove passing substantially in the diagonal direction through the opposing corners of the blade bit, and that in the whole consisting of the blade bit and its chuck there is also arranged a structure preventing the blade bit from wobbling, which structure consists of continuous, raised edge zones of either one or both of the surfaces to be placed against one another.

Preferred embodiments of the invention are disclosed in claims 2 to 6.

Previously, blade bits and chuck structures having a flat surface have been used, and only a V-groove, into which the chuck structure is arranged, has prevented the blade bit from rotating. In that case, in the final tightening stage of blade mounting the blade has tended to twist and detach from the support surfaces provided by the V-groove. After thermal treatment, the flat support surface of the rear of the blade bit becomes convex, whereby the blade wobbles in the chuck structure.

The solution of the invention eliminates in a simple manner all the problems encountered in previous blade bit attachment techniques.

### LIST OF FIGURES

The invention will now be described in more detail by means of some preferred exemplary embodiments, with reference to the attached drawings, in which

FIG. 1 is a perspective view of a blade bit for a crusher rotor and attachment thereof to a surface of the crusher rotor seen obliquely from the front,

FIG. 2 is a perspective side view of a blade bit for a crusher rotor and attachment thereof to a surface of the crusher rotor,

FIG. 3 is a rear view of the blade bit of the invention,

FIG. 4 is a sectional view along A-A of the blade bit of FIG. 3,

FIG. 5 is a front view of a chuck or hammering protection used in connection with the blade bit of the invention,

FIG. 6 is a sectional view along B-B of the chuck or hammering protection of FIG. 5,

FIG. 7 is a cross-sectional view, similar to that in FIG. 4, of a second, non-inventive blade bit, and

FIG. 8 is a cross-sectional view, similar to that in FIG. 6, of a second chuck or hammering protection used in connection with a non-inventive blade bit.

### DETAILED DESCRIPTION OF THE INVENTION

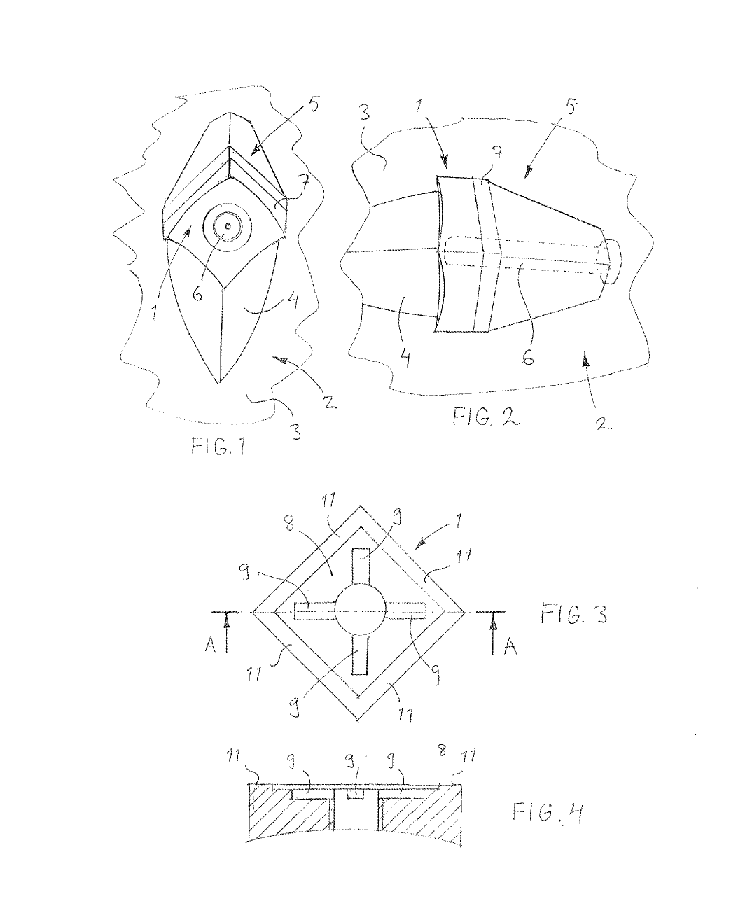

With reference to FIGS. 1 and 2, they show a blade bit 1, which is attached to a chuck 5 locating in a V-groove 4 on an envelope surface 3 of a crusher rotor 2 with a screw 6 passing centrally through the blade bit 1. The blade bit 1 has four corners (a square or a quadrangle typically having right angles) and it is attached to the chuck 5 such that an angular-shaped tip of the blade bit points substantially outwardly from the envelope surface 3 in the radial direction of the rotor 2. The chuck 5 may comprise a replaceable hammering protection 7 used in this example between the chuck 5 and the blade bit 1.

According to the invention, the blade bit's 1 rear surface 8, which acts as its attachment surface to the chuck 5 or hammering protection 7, comprises a support surface preventing the blade bit 1 from rotating, the support surface comprising, in the example of FIGS. 3 and 4, grooves 9 substantially in parallel with the diagonal lines of the square through the tips of the blade bit 1 and in alignment therewith. In that case, the chuck 5 or the hammering protection 7 have correspondingly counterpart support surfaces cooperating with the grooves 9, i.e. protrusions 10 appearing in FIGS. 5 and 6, which may be arranged with a selected sliding fit into the grooves 9. In this example, the protrusions 10 are arranged only for the grooves 9 of the blade bit 1 in the radial direction of the crusher rotor 2. When the blade bit 1 is being attached, the support surface 9 enables the blade bit 1 to be slid towards the envelope surface 3 until the blade bit 1 is supported to the envelope surface 3.

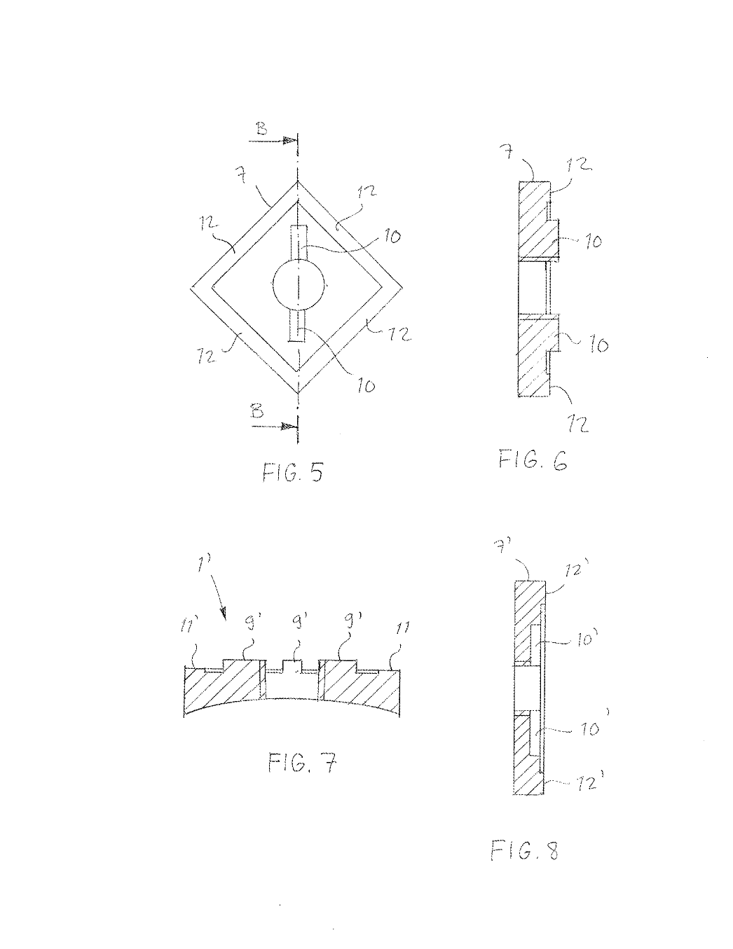

In the implementation of FIGS. 7 and 8, which is not inventive, the grooves and the protrusions may also change places in the blade bit 1′ and the chuck 5′ or the hammering protection 7′. So, the blade bit 1′ comprises the protrusions 9′, and the chuck 5′ or the hammering protection 7′ comprises the grooves 10′.

The number, orientation and shape, as well as the cross-sectional shape, of the above described grooves and protrusions 9, 10 may vary greatly and according to need. The cross section may be a rectangle, as described here, but it may also be a trapezoid, a triangle, a semi-circle or the like guiding structure. It is essential that the orientation of the tip of the blade bit 1 does not change with respect to the longitudinal axis of the crusher rotor 2. Instead, the above anti-rotation support surfaces 9, 10 may controllably allow a transition or adjustment of the blade bit 1 in the height direction. Advantageously, the blade bit 1 may be rotated here at 90-degree intervals, whereby all four cutting edges of the blade bit 1 may be used and “worn out” before the blade bit 1 is to be replaced.

The blade bit 1 being provided with grooves 9, the front surface (cutting surface) thereof may be reinforced, if necessary, so as to compensate for the weakening effect of the grooves 9. Actual impacts directed to the blade bits 1 are still to be received by the support surfaces formed by the flanks of the V-groove 4 in the envelope surface 3 of the crusher rotor 2.

In the above-described examples, in the whole consisting of the blade bit 1 and its chuck 5, 7 there is also arranged a structure that prevents the blade bit 1 from wobbling, the structure consisting of raised edge zones 11, 12, which may be continuous or discontinuous, of either one or both of the surfaces to be placed against one another. Thus, the structures that are mainly peripherally supported against one another are not able to wobble.

All above-described support surfaces 9, 10 preventing the blade bit 1 from rotating and structures 11, 12 preventing it from wobbling may be manufactured by machining or by using some other suitable manner. The protrusions 10, and possibly also the raised edge zones 11, 12, may also be separate elements attached to each particular part in a suitable manner.

The hammering protection 7 may likewise be manufactured of various steel grades and heat treated, tempered, coated, etc., in a suitably selected manner. The purpose of the hammering protection 7 is to protect the chuck 5 that is attached to the envelope surface 3 of the crusher rotor 2 and that is cumber-some to replace.

The size of the blade bit, 1, 1′ of the invention, in turn, is in the order of 40 mm×40 mm to 150 mm×150 mm, because it is employed in a relatively heavy-duty crusher.

The above description of the invention is only intended to illustrate the basic idea of the invention. A person skilled in the art may, however, implement the basic idea of the invention in a variety of ways. The invention and its embodiments are thus not restricted to the examples described above, but they may vary within the scope of the attached claims.

1. Blade bit to be attached to a chuck (5) in an envelope surface (3) of a crusher rotor (2), the blade bit (1) having four corners and arranged to be attached to the chuck such that an angular-shaped tip of the blade bit points outwardly from the envelope surface substantially in the radial direction of the rotor, whereby the rear surface of the blade bit (1) , which acts as its attachment surface to the chuck (5), comprises a support surface (9) that prevents the blade bit from rotating and that enables sliding of the blade bit towards the envelope surface (3) when the blade bit is being attached, until the blade bit is supported to the envelope surface, characterized in that the support surface comprises at least one groove (9) passing substantially in the diagonal direction through the opposing corners of the blade bit (1), and that in the whole consisting of the blade bit (1) and its chuck (5) there is also arranged a structure preventing the blade bit from wobbling, which structure consists of continuous, raised edge zones (11, 12) of either one or both of the surfaces to be placed against one another.

2. The blade bit of claim 1, characterized in that the support surface comprises grooves (9) substantially in parallel with both diagonals of the blade bit (1).

3. The blade bit of claim 1, characterized in that the grooves (9) are substantially in alignment with the diagonals of the blade bit (1).

4. The blade bit of claim 1, characterized in that the chuck (5) comprises a counterpart protrusion (10) which is substantially in the radial direction of the rotor (2) and corresponds to the at least one groove (9) in the rear surface of the blade bit (1).

5. The blade bit of claim 4, characterized in that the chuck (5) comprises a replaceable hammering protection (7) and that the counterpart support surface (10) is arranged in this hammering protection.

6. The blade bit of claim 1, characterized in that its size is substantially within the range of 40 mm×40 mm to 150 mm×150 mm.
